(19) United States
(12) Patent Application Publication
(10) Pub. No.: US 2005/0289186 A1
(43) Pub. Date: Dec. 29, 2005

(54) DDL replication without user intervention

(75) Inventors: Qun Guo, Redmond, WA (US); Vaqar N. Pirzada, Sammamish, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 10/879,423

(22) Filed: Jun. 29, 2004

(51) Int. Cl. G06F 12/00

(52) U.S. Cl. 707/200

(57) ABSTRACT

Data declaration language (DDL) replication can be performed without stopping the system. In other words, DDL changes can be replicated seamlessly. Within a RDBMS (relational database management system), the execution of a DDL statement involves many internal steps which are not visible to an end user. These steps can be logically divided into three stages, “pre-stage” which refers to the steps before the server makes a physical change to the system catalog for the specific DDL, “middle-stage” which refers to the action of making a change to the system catalog, and “post-stage” which refers to the steps after changes to the system catalog were made. Schema changes are intercepted in both pre-stage and post-stage. Schema changes are intercepted in pre-stage so an old image of schema information can be saved. This helps to support schema versioning logic. Schema changes are intercepted in post-stage so sets of commands can be posted to propagate the schema change, as well as to refresh any dependencies. This is desirably performed before the DDL command commits so all updates are protected by the same transaction. Moreover, the schema change and related updates are propagated in the same connection as DML changes, honoring the original sequence of action from the publishing side.

### FIELD OF THE INVENTION

This invention relates to the field of data management. More particularly, the invention relates to replication of data declaration language (DDL).

### BACKGROUND

Data manipulation language (DML) modifies data and includes changes such as inserting, deleting, and updating of user data. On the other hand, data declaration language (DDL) affects the structure of a table, but not the data contained in the table. Thus, DDL changes the schema. Exemplary DDL changes include adding, dropping, and altering columns to replicated tables. DML replication is well known. In recent years, there has been an increasing demand for replication of DDL changes.

Replication of DDL is challenging because not only the explicit changes to schema need to be replicated over (as in the DML replication case), but all dependence on the publishing and subscribing sides need to be refreshed to reflect the new schema. With respect to publishing and subscribing sides, a transaction log records things that will occur on the publishing side.

Furthermore, versions of schema need to be tracked so that the proper matching schema can be associated with sets of data (DML) changes as they occurred originally. For example, if an integer column is being changed to a character column, the same change needs to be made on the subscriber side, and any depending stored procedures or triggers should get regenerated to reference this column as a character instead of an integer. In addition, any inserts performed on the publishing side before this DDL should be handled with the knowledge that the column was an integer and any inserts after the DDL should be handled as character. While a brute-force solution may simply dictate a complete quiescent of the system, this is undesirable because the system must be stopped and then the DDL commands are run, and then the system is re-started. This is not efficient and is very labor intensive. Moreover, should a DDL change be ignored, the system will ultimately fail and a re-start will be necessary.

From the foregoing it is appreciated that there exists a need to overcome these deficiencies.

### SUMMARY OF THE INVENTION

The following summary provides an overview of various aspects of the invention. It is not intended to provide an exhaustive description of all of the important aspects of the invention, nor to define the scope of the invention. Rather, this summary is intended to serve as an introduction to the detailed description and figures that follow.

Data declaration language (DDL) replication can be performed without stopping the system. In other words, DDL changes can be replicated seamlessly. Within a RDBMS (relational database management system), the execution of a DDL statement involves many internal steps which are not visible to an end user. These steps can be logically divided into three stages, “pre-stage” which refers to the steps before the server makes a physical change to the system catalog for the specific DDL, “middle-stage” which refers to the action of making a change to the system catalog, and “post-stage” which refers to the steps after changes to the system catalog were made. With this invention, schema changes are intercepted in both pre-stage and post-stage. Schema changes are intercepted in pre-stage so an old image of schema information can be saved. This helps to support schema versioning logic. Schema changes are intercepted in post-stage so sets of commands can be posted to propagate the schema change, as well as to refresh any dependencies. This is desirably performed before the DDL command commits so all updates are protected by the same transaction. Moreover, the schema change and related updates are preferably propagated in the same connection as DML changes, honoring the original sequence of action from the publishing side. It is noted that a system catalog is a set of system tables which holds schema for the objects (tables, indexes, procedures, etc) within the database.

An exemplary embodiment for performing DDL replication comprises receiving a DDL command which affects schema in a table, intercepting the change before it is made to a system catalog, and storing information regarding the current state of the schema in the table, then intercepting after changes are made to the system catalog and before being committed, and then storing the changes. The changes are then ready to be propagated to provide replication.

According to aspects of the invention, storing the information regarding the current state of the schema comprises logging the schema, by intercepting a schema change and storing a copy of a previous image of the schema being changed.

According to further aspects of the invention, a DDL command is intercepted after the changes have been made to the system catalog but before it is committed.

Other features and advantages of the invention may become apparent from the following detailed description of the invention and accompanying drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIGS. 1 and 2 are schematic illustrations of exemplary computing environments suitable for the present invention, with FIG. 2 depicting an exemplary networked computing environment;

FIG. 3 is a flow diagram of an exemplary method of DDL replication in accordance with the present invention; and

FIG. 4 is a block diagram of an exemplary system that is useful for describing aspects of the present invention.

### DETAILED DESCRIPTION OF THE INVENTION

The subject matter is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described.

Exemplary Computing Environment

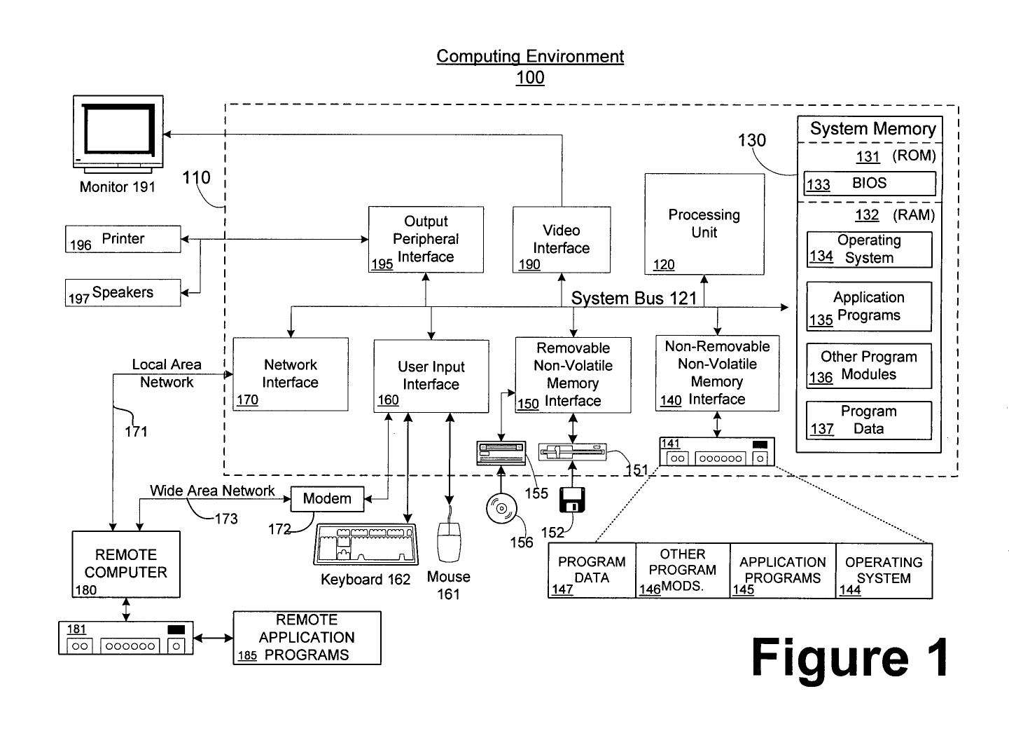

FIG. 1 illustrates an example of a suitable computing system environment 100 in which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and non-volatile media, removable and non-removable media. By way of example, and not limitation, computer readable media may comprise computer storage media and communication media. Computer storage media includes both volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or non-volatile memory such as ROM 131 and RAM 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/non-volatile computer storage media. By way of example only, FIG. 1 illustrates a hard disk drive 140 that reads from or writes to non-removable, non-volatile magnetic media, a magnetic disk drive 151 that reads from or writes to a removable, non-volatile magnetic disk 152, and an optical disk drive 155 that reads from or writes to a removable, non-volatile optical disk 156, such as a CD-ROM or other optical media. Other removable/non-removable, volatile/non-volatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Exemplary Networked Computing Environment

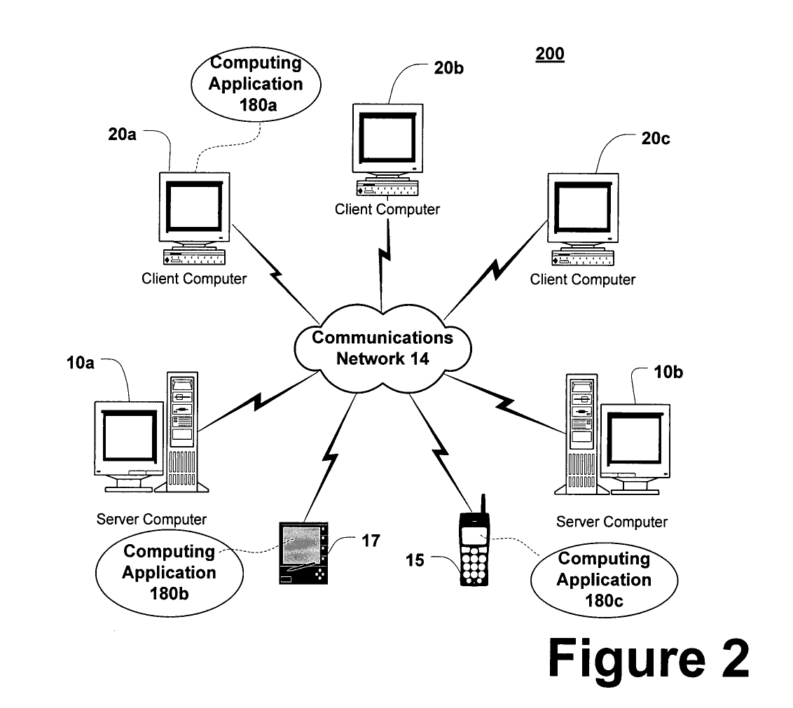

Computer environment 100, described above, can be deployed as part of a computer network. In general, the above description for computers applies to both server computers and client computers deployed in a network environment. FIG. 2 illustrates an exemplary network environment 200, with a server in communication with client computers via a network, in which the present invention may be employed. As shown in FIG. 2, a number of servers 10a, 10b, etc., are interconnected via a communications network 14 (which may be a LAN, WAN, intranet, the Internet, or other computer network) with a number of client computers 20a, 20b, 20c, or computing devices, such as, mobile phone 15 and personal digital assistant 17. In a network environment in which the communications network 14 is the Internet, for example, the servers 10 can be Web servers with which the clients 20 communicate via any of a number of known protocols, such as, hypertext transfer protocol (HTTP) or wireless application protocol (WAP). Each client computer 20 can be equipped with browser 180a to gain access to the servers 10. Similarly, personal digital assistant 17 can be equipped with browser 180b and mobile phone 15 can be equipped with browser 180c to display and receive various data.

In a typical database system, a user (not shown) may interact with a computing application (e.g. database system) running on a server computing devices. The interaction involves reading and writing the data in units called transaction. In an exemplary environment, the transactions may be performed on one server (S1) and shipped to a second server (S2) where they are used to keep an up-to-date copy of the database. The transaction logs and log sequence numbers may be stored on server computers and communicated to cooperating servers (running cooperating database applications) over communications network 14. S1 and S2 may perform the resynchronization of multiple copies of a database after a divergence in transaction history. A user may initiate or monitor in the resynchronization activities by interfacing with computing applications through client computing devices. These transactions may be communicated by client computing devices to server computers for processing and storage.

Thus, the herein described systems and methods can be utilized in a computer network environment having a plurality of server computers in communication and interaction with each other. However, the systems and methods described herein can be implemented with a variety of network-based architectures, and thus should not be limited to the example shown. The herein described systems and methods will now be described in more detail with reference to a presently illustrative implementation.

Exemplary Embodiments

Data declaration language (DDL) replication can be performed without stopping the system. In other words, DDL changes can be replicated seamlessly. Within a RDBMS (relational database management system), the execution of a DDL statement involves many internal steps which are not visible to an end user. These steps can be logically divided into three stages, “pre-stage” which refers to the steps before the server makes a physical change to the system catalog for the specific DDL, “middle-stage” which refers to the action of making a change to the system catalog, and “post-stage” which refers to the steps after changes to the system catalog were made, as described further herein.

Schema changes are intercepted in both pre-stage and post-stage. Schema changes are intercepted in pre-stage so schema information can be saved. This helps to support schema versioning logic. Schema changes are intercepted in post-stage so set(s) of commands can be posted to propagate the schema change, as well as to refresh any dependencies. This is desirably performed before the DDL command commits so all updates are protected by the same transaction. Moreover, the schema change and related updates are propagated in the same connection as DML changes, honoring the original sequence of action from the publishing side.

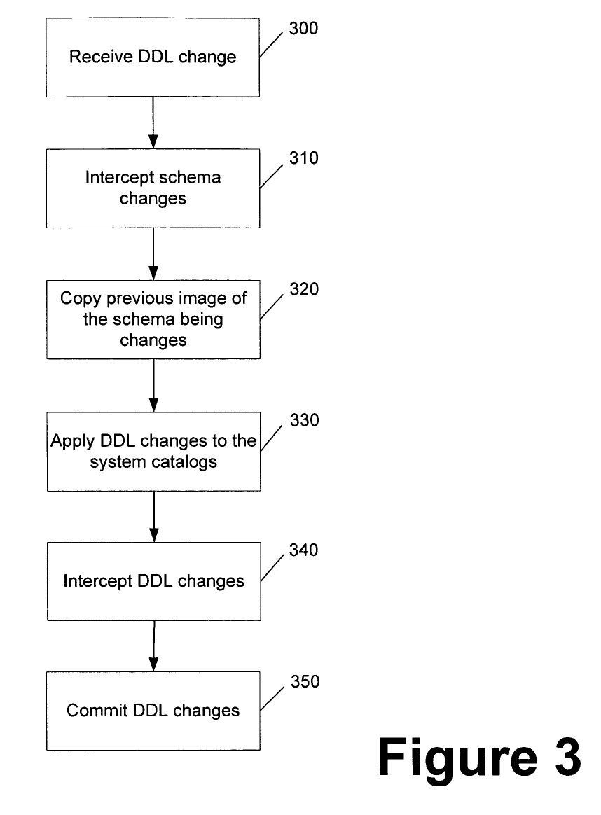

FIG. 3 is a flow diagram of an exemplary method of DDL replication in accordance with the present invention. A DDL change (or command) is received, at step 300. A DDL change may affect the name, physical storage attributes (e.g., which offset to store in a data row, size of the column, etc.), or logical attributes (e.g., whether the column is an expression based on other columns, etc.) of an existing column, or it may add new columns or drop existing columns, for example.

Information regarding the current schema is written into a transaction log before anything changes. Desirably, schema changes are intercepted in a pre-stage, at step 310. At this point, the DDL statement processing (e.g., in the backend server) is intercepted, and a copy of the previous image of the schema being changed is saved, at step 320. This is performed so that any DML changes prior to this can be replicated with the saved version of schema instead of live ones which no longer match. The interception is desirably performed by providing an interface (e.g., for the backend server) to invoke, at the appropriate time, before the actual DDL change is made in associated system catalogs.

Therefore, the information that is saved is desirably sufficient to show what the schema looked like (i.e., the old schema is logged). This information can be used to process the transaction log prior to this point, and provides assistance with versioning.

The DDL changes are made to the system catalog(s), at step 330. In other words, for example, the server then implements the DDL command(s) to make the physical changes.

Before the control returns to the user or server (e.g., further DML commands or changes are accepted/implemented), post-stage processing is performed. The DDL changes (including the ones which do not change column attributes, do not add a new column or drop existing columns, such as ‘alter table add constraint . . . ’) are intercepted again, at step 340, after actual changes are made in system catalogs but before the command commits. Thus, sets of commands can be posted to propagate a) the DDL change itself, b) the updates to replication metadata so it is aware of the new schema, and c) the updates to refresh dependencies on the publishing and subscribing sides. This interception may be performed by utilizing the backend “Eventing” infrastructure, for example, or more particularly, by defining a set of actions in response to the DDL change event posted by the backend infrastructure.

At step 350, the DDL change(s) commits and subsequent changes (e.g., DML changes) may be made. Thus, the new schema is consumed, the DDL completes, and the user or server regains control.

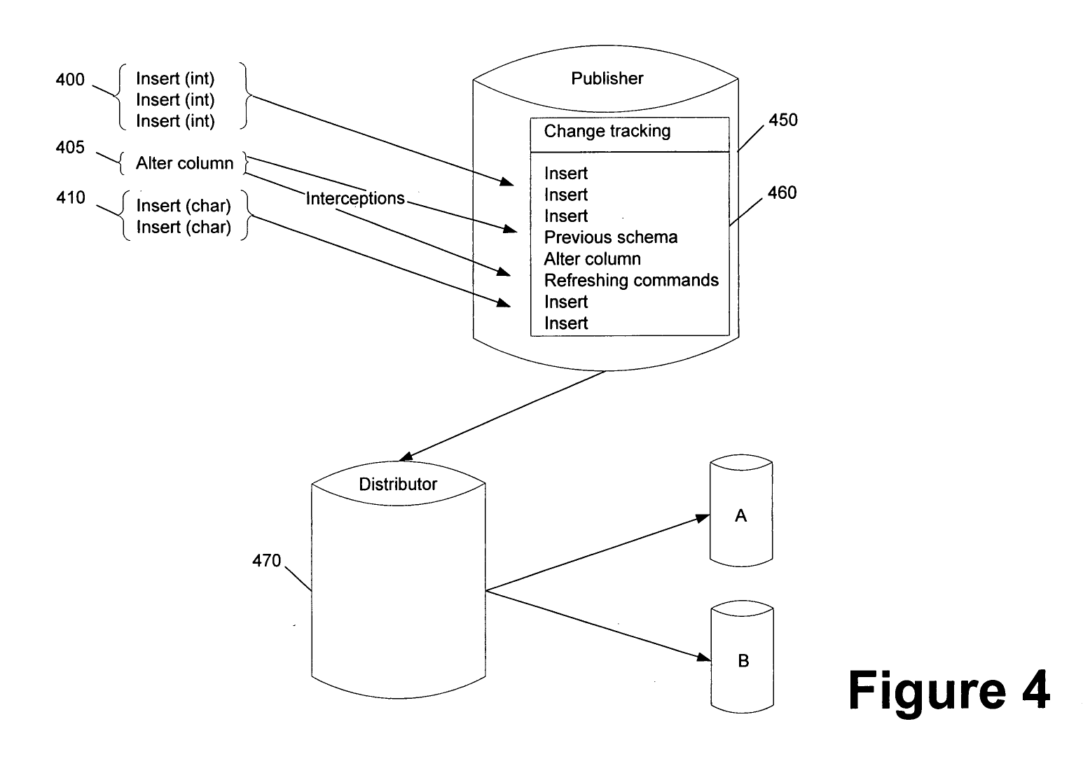

Therefore, DDL changes and updates to dependencies posted by the replication honor the original sequence as it happened on publishing side, so they can be safely propagated among other replicated DML commands (e.g., by distribution components). As an example, consider the command sequence in which three inserts to a table with column A as integers are ordered, followed by a DDL change to make column A into a character field, and then followed by two more inserts. This example may be described with respect to the exemplary system diagram shown in FIG. 4.

The command sequence is shown as comprising a set of DML commands 400, DDL command 405, and a set of DML commands 410. The DML commands 400 are executed. For example, DML commands “insert (int)” are performed such that the column in the underlying table is an “integer” column. These inserts are shown in the change tracking transaction log 460, which desirably resides at the publisher 450, but may be stored in any data store or storage device.

The DDL command 405 is received after the set of DML commands 400. As shown, the DDL command “alter column” changes the column from an “integer” column to a “character” column. Thus, upon receiving the DDL command 405, a pre-stage interception takes place (e.g., step 310), processing of the DDL command occurs (e.g., steps 320, 330), and a post-stage interception takes place (e.g., step 340). The results of such processing are shown in the transaction log 460. For example, the alter table column is shown in the transaction log, followed by commands to refresh dependencies.

At this point, the DDL change is committed, and processing of the subsequent sets of DML commands 410 may occur. As shown, the DML commands “insert (char)” are performed such that the column in the underlying table is a “character” column.

The transaction log 460 is scanned and replicated transactions/commands are constructed as result of the scanning. These transactions/commands are sent to the distributor 470, which acts as a staging area. The transactions are then provided to subscribers A and B responsive to requests. The distribution components will deliver the changes in the same order as in the transaction log, without any user intervention.

Thus, replication is provided where the schema may be changed frequently, and quiescent of the system is impractical or undesirable.

Conclusion

The various systems, methods, and techniques described herein may be implemented with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computer will generally include a processor, a storage medium readable by the processor (including volatile and non-volatile memory and/or storage elements), at least one input device, and at least one output device. One or more programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the invention. When implemented on a general-purpose processor, the program code combines with the processor to provide a unique apparatus that operates to perform the functionality of the present invention.

While the present invention has been described in connection with the preferred embodiments of the various figures, it is to be understood that other similar embodiments may be used or modifications and additions may be made to the described embodiments for performing the same functions of the present invention without deviating therefrom. Therefore, the present invention should not be limited to any single embodiment, but rather construed in breadth and scope in accordance with the appended claims.

1. A method of performing replication, comprising:
receiving a command in a first data language to affect schema in a table;
storing information regarding the current state of the data in the table;
making a change to a system catalog responsive to the received command;
intercepting the changes after being made to the system catalog and before being committed;
storing the changes; and
committing the changes to provide replication.

2. The method of claim 1, wherein the first data language is a data declaration language (DDL).

3. The method of claim 1, wherein the command affects the name, physical storage attributes, or logical attributes of a column in the table, or adds new columns or drop existing columns of the table.

4. The method of claim 1, wherein storing the information regarding the current state of the data comprises writing the information into a transaction log.

5. The method of claim 1, wherein storing the information regarding the current state of the data comprises logging the schema.

6. The method of claim 5, wherein logging the schema comprises intercepting a schema change and storing a copy of a previous image of the schema being changed.

7. The method of claim 1, wherein making the change to the system catalog comprises implementing the received command to make a physical change.

8. The method of claim 1, further comprising accepting and implementing a command in a second data language after committing the changes.

9. The method of claim 8, wherein the first data language is a data declaration language (DDL) and the second data language is a data manipulation language (DML).

10. The method of claim 1, further comprising accepting and implementing a command in a second data language prior to receiving the command in the first data language.

11. The method of claim 10, wherein the first data language is a data declaration language (DDL) and the second data language is a data manipulation language (DML).

12. The method of claim 11, wherein the replication is performed without quiescent

13. The method of claim 1, wherein storing the changes comprises updating replication metadata to comply with a new schema and writing updates which refresh dependences to a transaction log.

14. The method of claim 1, wherein storing the changes propagates the change itself, provides updates to replication metadata so it is aware of the new schema, and refreshes dependencies on the publishing and subscribing sides.

15. A method of data replication, comprising:
performing pre-stage processing on a DDL command;
changing a system catalog responsive to the DDL command;
performing post-stage processing on the DDL command; and
committing the DDL command to provide data replication.

16. The method of claim 15, wherein the pre-stage processing comprises intercepting a schema change and storing information related to the schema change.

17. The method of claim 15, wherein the post-stage processing comprises intercepting a schema change and storing a set of commands to propagate the schema change and refresh any dependencies.

18. The method of claim 15, wherein the data replication is performed without quiescent.

19. A computer-readable medium having a data structure stored thereon, the data structure comprising a transaction log comprising a first plurality of commands generated responsive to commands received in a first data language, and a second plurality of commands generated responsive to commands received in a second data language, the second plurality of commands providing data replication without quiescent.

20. The computer-readable medium of claim 19, wherein the first data language is a data manipulation language (DML) and the second data language is a data declaration language (DDL).

21. The computer-readable medium of claim 19, wherein the transaction log further comprises a third plurality of commands generated responsive to further commands received in the first data language, the third plurality of commands being ordered to execute after the second plurality of commands.

22. A system for providing data replication, comprising:
a publisher comprising a transaction log comprising a first plurality of commands generated responsive to commands received in a first data language, and a second plurality of commands generated responsive to commands received in a second data language; and
a distributor for receiving commands constructed from the transaction log from the publisher and forwarding the commands to a subscriber.

23. The system of claim 22, wherein the first and second plurality of commands sent to the distributor are in the same order as in the transaction log, without user intervention.

24. The system of claim 22, wherein the first data language is a data manipulation language (DML) and the second data language is a data declaration language (DDL).
